(19) United States
(12) Patent Application Publication
(10) Pub. No.: US 2021/0243192 A1
(43) Pub. Date: Aug. 5, 2021

(54) Apparatus and Method for Internet Access Control of IoT Device

(71) Applicant: GREEN ZONE SECURITY., LTD., Hyeonpung-myeon (KR)

(72) Inventor: Shin KIM, Gimpo-si (KR)

(21) Appl. No.: 16/965,253

(22) PCT Filed: Oct. 18, 2019
(86) PCT No.: PCT/KR2019/013712

§ 371 Date: Jul. 27, 2020

(30) Foreign Application Priority Data
Mar. 21, 2019 (KR) 10-2019-0032221

(51) Int. Cl. H04L 29/06

(52) U.S. Cl. CPC H04L 63/101; H04L 63/0876; H04L 63/20; H04L 63/104

(57) ABSTRACT

A policy file server for Internet access control according to the present invention includes a storage unit storing a policy file to specify a destination IP and port to which access has been approved with respect to each of a plurality of devices, a communication unit receiving, from any one of the plurality of devices, a policy file request message including a device ID and a hash value of a policy file already received by the device, and a controller updating a policy file for the plurality of devices in a given cycle, determining whether the policy file has been updated based on the hash value of the device when the policy file request message is received, and transmitting, to the device, a policy file response message including the updated policy file through the communication unit if the policy file has been updated.

### TECHNICAL FIELD

The present invention relates to an Internet access control technology and, more particularly, to an apparatus and method for Internet access control of an Internet of Things (IoT) device.

### BACKGROUND ART

Conventionally, a network access device (wireless access point, etc.) receives an access policy file from a control file server, configures an access control list (ACL), and performs access control over an IoT device. In such a case, precise setting is difficult for each IoT device because the IoT devices are collectively controlled by the network access device. Furthermore, in terms of a system configuration, a policy file server and a policy operation manager need to be added. The complexity of a system is increased because a protocol for supporting each of the network access device and the IoT device needs to be implemented in each of the network access device and the IoT device. Furthermore, the existing products in which protocols have not been implemented like a network access device cannot be used.

### DISCLOSURE

### Technical Problem

An object of the present invention is to simplify a configuration using only an IoT device and a policy file server and to enable more flexible access control by setting a policy file for each IoT device or setting a policy file in a group of IoT devices.

### Technical Solution

To achieve the object, a policy file server for Internet access control according to an embodiment of the present invention includes a storage unit storing a policy file to specify a destination IP and port to which access has been approved with respect to each of a plurality of devices, a communication unit receiving, from any one of the plurality of devices, a policy file request message including a device ID and a hash value of a policy file already received by the device, and a controller updating a policy file for the plurality of devices in a given cycle, determining whether the policy file has been updated based on the hash value of the device when the policy file request message is received, and transmitting, to the device, a policy file response message including the updated policy file through the communication unit if the policy file has been updated.

The policy file request message further includes a digital signature of the device. The controller verifies forgery of the policy file request message based on the digital signature, and transmits, to a manager apparatus, a warning message providing notification that the policy file request message has been forged through the communication unit if, as a result of the verification, the policy file request message has been forged.

The controller periodically receives an IP use speed from each of the plurality of devices, classifies the plurality of devices into a plurality of groups based on the IP use speeds, and updates a policy file based on each of the classified groups.

To achieve the object, a device for Internet access control according to an embodiment of the present invention includes a storage module storing a basic permission list to specify a destination IP to which access has been approved and a policy file to specify a destination IP and port to which access has been approved, a communication module for communication with a policy file server, and an access policy file manager receiving an updated policy file from the policy file server in a given cycle through the communication module.

The device further includes an access control filter module determining whether a destination IP of an IP packet is included in the destination IP specified by the basic permission list when the IP packet is received from an IP layer, determining whether the destination IP and port of the IP packet are included in the destination IP and port to which access has been approved by the policy file if, as a result of the determination, the destination IP of the IP packet is not included in the destination IP specified by the basic permission, and transmitting the IP packet to a lower layer if, as a result of the determination, the destination IP of the IP packet is included in the destination IP specified by the basic permission.

To achieve the object, a method for Internet access control by a policy file server according to an embodiment of the present invention includes the steps of updating a policy file to specify a destination IP and port to which access has been approved in a given cycle with respect to each of a plurality of devices, receiving, from any one of the plurality of devices, a policy file request message including a device ID and a hash value of a policy file already received by the device, and determining whether the policy file has been updated based on the hash value of the device and transmitting, to the device, a policy file response message including the updated policy file if the policy file has been updated.

To achieve the object, a method for Internet access control of a device according to an embodiment of the present invention includes the steps of storing a basic permission list to specify a destination IP to which access has been approved, storing a policy file to specify a destination IP and port to which access has been approved and updating the policy file in a given cycle, determining whether a destination IP of an IP packet is included in the destination IP specified by the basic permission list when the IP packet is received from an IP layer, determining whether the destination IP and port of the IP packet are included in the destination IP and port to which access has been approved by the policy file if, as a result of the determination, the destination IP of the IP packet is not included in the destination IP specified by the basic permission list, and transmitting the IP packet to a lower layer if, as a result of the determination, the destination IP and port of the IP packet are included in the destination IP and port to which access has been approved by the policy file.

### Advantageous Effects

According to the present invention, data transmission security of an IoT device can be improved by allowing the IoT device to not transmit data through an unapproved IP and port and to implement an Internet access control through only a destination IP and port to which access has been approved.

### DESCRIPTION OF DRAWINGS

FIG. 1 is a diagram for describing a configuration of a system for Internet access control according to an embodiment of the present invention.

FIG. 2 is a block diagram for describing a configuration of a policy file server according to an embodiment of the present invention.

FIG. 3 is a block diagram for describing a configuration of a device according to an embodiment of the present invention.

FIG. 4 is a flowchart for describing a method for Internet access control of an IoT device according to an embodiment of the present invention.

FIG. 5 is a flowchart for describing a method for Internet access control of an IoT device by a policy file server according to an embodiment of the present invention.

FIG. 6 is a flowchart for describing a method for Internet access control of an IoT device by a device according to an embodiment of the present invention.

FIG. 7 is a flowchart for describing a method for Internet access control of an IoT device by a device according to an embodiment of the present invention.

### MODE FOR INVENTION

Prior to the detailed description of the present invention, terms or words used in the specification and claims described hereunder should not be construed as having common or dictionary meanings, but should be construed as having meanings and concepts that comply with the technical spirit of the present invention based on the principle that the inventor may appropriately define the concepts of the terms in order to describe his or her invention in the best manner. Accordingly, embodiments described in the specification and elements shown in the drawings are merely the most preferred embodiments of the present invention and do not fully represent the technical spirit of the present invention. Accordingly, it should be understood that a variety of equivalents and modifications capable of substituting the embodiments and elements at the time of filing of this application may be present.

Preferred embodiments of this invention are described in detail below with reference to the accompanying drawings. It is to be noted that the same reference numbers are used throughout the drawings to refer to the same elements. Furthermore, a detailed description of known functions or elements that may make the gist of this invention vague will be omitted. For the same reason, in the accompanying drawings, some elements are enlarged, omitted, or depicted schematically. Furthermore, the size of each element does not accurately reflect its real size.

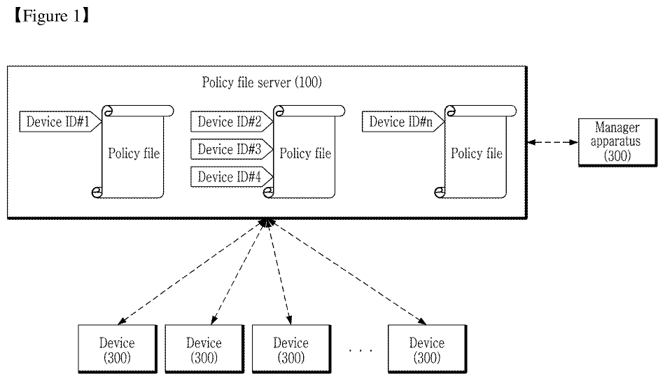

First, a system for Internet access control according to an embodiment of the present invention is described below. FIG. 1 is a diagram for describing a configuration of a system for Internet access control according to an embodiment of the present invention. Referring to FIG. 1, the system for Internet access control (hereinafter abbreviated as an “access control system”) according to an embodiment of the present invention includes a policy file server 100 and a plurality of Internet of Things (IoT) devices 200 (hereinafter abbreviated as “devices”). Furthermore, optionally, the access control system may further include a manager apparatus 300.

The policy file server 100 generates or updates a policy file for controlling only a destination IP and port to which access is approved to be accessed in order to improve the security of the device 200. The format of the policy file is generated in a format supported by the device 200, such as xml or text. The policy file server 100 may individually set a policy file in a device ID registered with each of a plurality of the devices 200 or may classify the plurality of devices 200 into groups and set one policy file in each group. Accordingly, the policy file server 100 may manage the policy file for each device 200 or manage the policy file for each group.

According to an embodiment, the policy file server 100 transmits a policy file to the device 200 in response to a request from the device 200. When an IP packet is generated, the device 200 processes whether to transmit the IP packet by comparing the destination IP and port of the corresponding IP packet based on the received policy file. The policy file server 100 may set the request cycle of the policy file of the device 200, if necessary.

When a policy file request is received from the device 200, the policy file server 100 transmits a corresponding policy file in response to the policy file request. When requesting the policy file, the device 200 transmits, to the policy file server 100, a device ID and a hash value of the policy file if the policy file is present. Furthermore, when requesting the policy file, the device 200 may additionally transmit a recently received policy file update time, location information of the device, etc.

The device 200 may request a policy file periodically or if necessary. If an already received policy file is not present, the device 200 receives a policy file by transmitting only the ID of the device. The policy file server 100 determines whether a policy file for a corresponding device 200 has been updated by checking whether a hash value of the policy file corresponding to the device ID is identical with a hash value received from the device. The policy file server 100 transmits a new policy file if the hash value has been changed, and notifies the device 200 that update contents are not present if the hash value has not been changed.

According to another embodiment, furthermore, the policy file server 100 may force a policy file to be updated from the policy file server 100 to the device 200, if necessary. If the policy file server 100 has updated a policy, the policy file server 100 may generate a request for updating a policy file. Communication between the policy file server 100 and the device 200 may be maintained through a secure channel, such as HTTPS.

If a policy file transmitted to the device 200 has been forged, when the device 200 notifies the policy file server 100 of the forgery of the policy file, the policy file server 100 notifies the manager apparatus 300 of the forgery of the policy file.

The manager apparatus 300 is for managing the policy file server 100 while operating in conjunction with the policy file server 100, and is an apparatus used by the manager of the policy file server 100. The manager apparatus 300 may be any apparatus capable of performing a computing operation and performing communication over a network. For example, the manager apparatus 300 may be applied to various terminals, such as an information communication device, a multimedia terminal, a wired terminal, a stationary type terminal and an Internet protocol (IP) terminal. For example, the manager apparatus 300 may include a mobile phone, a portable multimedia player (PMP), a mobile Internet device (MID), a smartphone, a tablet, a phablet, a notebook, etc. When the forgery of a policy file request message or a policy file response message is reported by the policy file server 100, the manager apparatus 300 may notify the manager of the forgery by displaying the forgery on a screen or u sing a voice signal so that the manager can take measures.

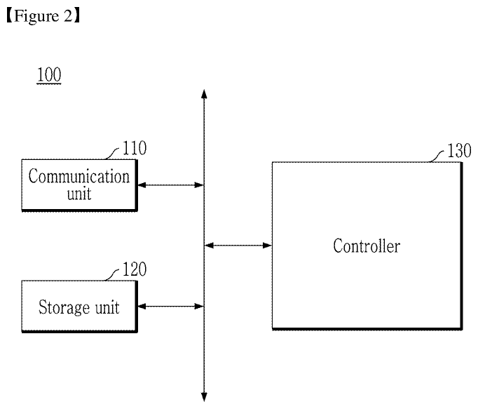

The policy file server 100 is described more specifically below. FIG. 2 is a block diagram for describing a configuration of the policy file server according to an embodiment of the present invention. Referring to FIG. 2, the policy file server 100 includes a communication unit 110, a storage unit 120 and a controller 130.

The communication unit 110 is means for communication with the device 200 or the manager apparatus 300. The communication unit 110 may include a radio frequency (RF) transmitter (Tx) for up-converting and amplifying the frequency of a transmitted signal and an RF receiver (Rx) for low-noise amplifying a received signal and down-converting the frequency of the received signal. Furthermore, the communication unit 110 includes a modem for modulating a transmitted signal and demodulating a received signal. The communication unit 110 may receive a policy file request message according to an embodiment of the present invention and transmit the policy file request message to the controller 130, and may receive a policy file response message from the controller 130 and transmit the policy file response message to the device 200.

The storage unit 120 functions to store a program and data necessary for an operation of the policy file server 100. In particular, the storage unit 120 stores the device ID of each of the plurality of devices 200 and a corresponding policy file. Furthermore, after the policy file is generated, the storage unit 120 may store a calculated hash value.

The controller 130 may control an overall operation of the policy file server 100 and a flow of signals between blocks within the policy file server 100, and may perform a data processing function for processing data. Furthermore, the controller 130 basically functions to control various functions of the policy file server 100. The controller 130 may include a central processing unit (CPU), a digital signal processor (DSP), etc., for example. The controller 130 generates a policy file, updates the policy file, and transmits the policy file to a corresponding device 200 through the communication unit 110. An operation of the controller 130 will be further described later.

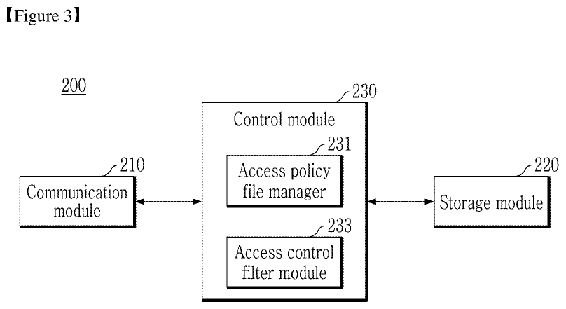

The device 200 according to an embodiment of the present invention is described below. FIG. 3 is a block diagram for describing a configuration of the device according to an embodiment of the present invention. Referring to FIG. 3, the device 200 includes a communication module 210, a storage module 220 and a control module 230.

The communication module 210 is means for communication with the policy file server 100. The communication module 210 may include a radio frequency (RF) transmitter (Tx) for up-converting and amplifying the frequency of a transmitted signal and an RF receiver (Rx) for low-noise amplifying a received signal and down-converting the frequency of the received signal. Furthermore, the communication module 210 includes a modem for modulating a transmitted signal and demodulating a received signal. The communication module 210 may receive a policy file request message from the control module 230 and transmit the policy file request message to the policy file server 100. Furthermore, the communication module 210 receives a policy file response message from the policy file server 100 and transmits the policy file response message to the control module 230.

The storage module 220 stores a program and data necessary for an operation of the device 200. In particular, the storage module 220 may store a policy file and a hash value of the policy file. The policy file and the hash value of the policy file stored in the storage module 220 may be updated in a given cycle.

The control module 230 may control an overall operation of the device 200 and a flow of signals between blocks within the device 200, and may perform a data processing function for processing data. Furthermore, the control module 230 basically functions to control various functions of the policy file server 100. The control module 230 may include a central processing unit (CPU), a digital signal processor (DSP), etc., for example. The control module 230 includes an access policy file manager 231 and an access control filter module 233. The access policy file manager 231 is for receiving a policy file from the policy file server 100. The access control filter module 233 is for performing access control based on the policy file. An operation of the control module 230 including the access policy file manager 231 and the access control filter module 233 will be further described later.

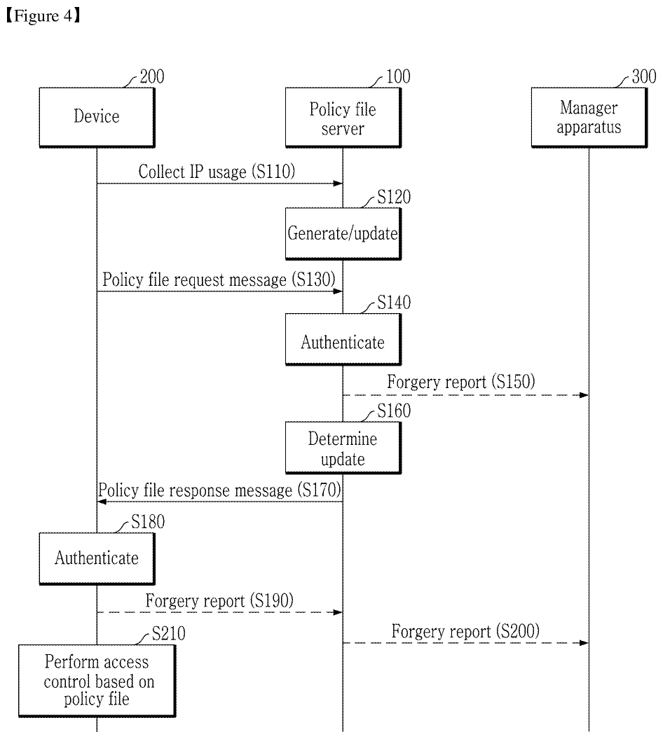

A method for Internet access control of an IoT device according to an embodiment of the present invention is described below. FIG. 4 is a flowchart for describing a method for Internet access control of an IoT device according to an embodiment of the present invention.

Referring to FIG. 4, the control module 230 of the device 200 counts the number of uses whenever an IP packet having a different destination IP is generated, and calculates an IP use speed according to Equation 1 below.

$$Sr = \frac{IPc}{T} \qquad [ Equation 1 ]$$

In this case, Sr is an IP use speed. IPc is the number of times that a previous IP packet and an IP packet having a different destination IP have been generated. T indicates a preset cycle.

The control module 230 of the device 200 transmits a device ID and an IP use speed to the policy file server 100 in a given cycle. Accordingly, at step S110, the controller 130 of the policy file server 100 may periodically collect the IP use speed of each of the plurality of devices 200.

At step S120, the controller 130 of the policy file server 100 generates or updates policy files for the plurality of devices 200. The policy file specifies a destination IP and port to which access is approved.

According to an embodiment, the controller 130 of the policy file server 100 may generate a policy file for each of the plurality of devices 200, and may update the policy file in a given cycle. According to another embodiment, the controller 130 may group the plurality of devices 200, and may update a policy file for each group. In this case, the controller 130 may set an update cycle for each group.

According to an additional embodiment, the controller 130 of the policy file server 100 may group the plurality of devices 200 based on the IP use speeds of the plurality of devices 200. In this case, the controller 130 may generate a group of devices 200 having similar IP use speeds using a clustering algorithm. Furthermore, the controller 130 may update a policy file for each group. In this case, the controller 130 may set an update cycle for each group. In particular, in the case of a group of devices 200 whose average IP use speed is high, the controller 130 may slowly set the update cycle of a policy file.

Meanwhile, at step S130, the policy file manager 231 of the control module 230 of the device 200 transmits a policy file request message to the policy file server 100 through the communication module 210. The policy file request message includes a device ID and a digital signature obtained by signing the device ID using the private key of the device 200. In particular, if the device 200 has already received a policy file, the policy file request message further includes a hash value of the already received policy file. If an already received policy file is not present, the policy file request message is transmitted without a hash value. Furthermore, the policy file request message may further include the update time of the most recently received policy file and location information of the device 200. As described above, the policy file manager 231 may generate the policy file request message periodically or, if necessary, when a policy file is not present, and may request a policy file.

When receiving the policy file request message through the communication unit 110, at step S140, the controller 130 of the policy file server 100 authenticates the policy file request message. As described above, the policy file request message includes a device ID and a digital signature obtained by signing the device ID using the private key of the device 200. Accordingly, the controller 130 extracts a device ID from the digital signature, obtained by signing the device ID using the private key of the device 200, using the public key of the device 200, and authenticates the policy file request message by verifying whether the extracted device ID is identical with the device ID included in the policy file request message.

If the authentication fails, at step S150, the controller 130 may transmit, to the manager apparatus 300, a forgery report providing notification that the policy file request message has been forged or falsified through the communication unit 110.

In contrast, if the authentication is successful, at step S160, the controller 130 of the policy file server 100 determines whether an updated policy file of the corresponding device 200 is present. If a hash value has not been included in the policy file request message, the controller 130 determines that the policy file request message has been first transmitted and generates a new policy file.

Meanwhile, if a hash value has been included in the policy file request message, the controller 130 compares a hash value of a policy file corresponding to a corresponding device ID with a hash value of the policy file request message. The controller 130 determines that the policy file has not been updated if the hash values are the same, and determines that the policy file of the corresponding device 200 has been updated if the hash values are different.

As described above, if it is determined that the policy file of the device 200 has been updated, at step S170, the controller 130 of the policy file server 100 transmits, to the device 200, a policy file response message including the policy file through the communication unit 110. In this case, the policy file response message includes the policy file and the digital signature of the policy file server 100. In this case, the controller 130 may generate the digital signature obtained by signing a corresponding device ID using the private key of the policy file server 100, and may include the digital signature in the policy file response message.

When receiving the policy file response message through the communication module 210, the policy file manager 231 of the control module 230 of the device 200 stores the received policy file response message in the storage module 220.

Thereafter, at step S180, the policy file manager 231 authenticates the policy file response message. As described above, the policy file response message includes the policy file, and the digital signature obtained by signing a corresponding device ID using the private key of the policy file server 100. Accordingly, the policy file manager 231 extracts the device ID from the digital signature, obtained by signing the device ID using the private key of the policy file server 100, using the public key of the policy file server 100, and authenticates the policy file response message by verifying whether the extracted device ID is identical with the device ID of the corresponding device.

If the authentication fails, at step S190, the policy file manager 231 may transmit, to the policy file server 100, a forgery report providing notification that the policy file request message has been forged or falsified through the communication module 210. In response thereto, at step S200, the controller 130 of the policy file server 100 may transmit, to the manager apparatus 300, the forgery report providing notification that the policy file request message has been forged or falsified through the communication unit 110. In contrast, if the authentication is successful, at step S210, the policy file manager 231 performs access control based on the corresponding policy file.

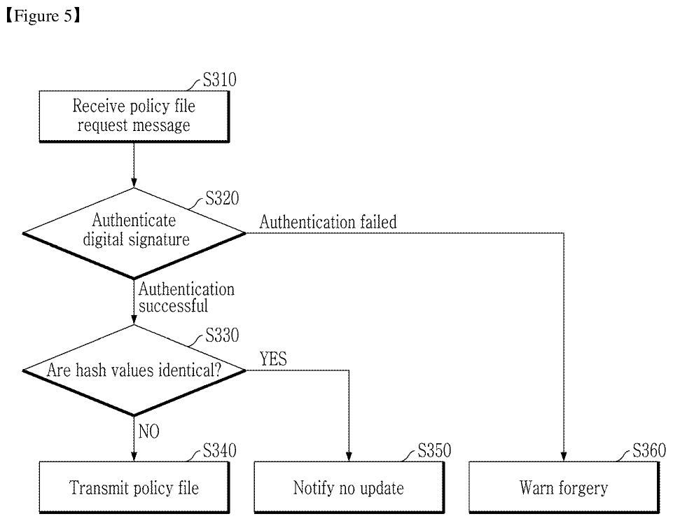

A method of transmitting a policy file by the policy file server 100 is described more specifically below. FIG. 5 is a flowchart for describing a method for Internet access control of an IoT device by the policy file server according to an embodiment of the present invention.

Referring to FIG. 5, at step S310, the controller 130 of the policy file server 100 may receive a policy file request message through the communication unit 110. In response thereto, at step S320, the controller 130 authenticates a digital signature. The policy file request message includes a device ID and the digital signature obtained by signing the device ID using the private key of the device 200. Accordingly, the controller 130 extracts the device ID from the digital signature, obtained by signing the device ID using the private key of the device 200, using the public key of the device 200, and authenticates the policy file request message by verifying whether the extracted device ID is identical with the device ID included in the policy file request message.

If the authentication fails, at step S360, the controller 130 may transmit, to the manager apparatus 300, a forgery report providing notification that the policy file request message has been forged or falsified through the communication unit 110.

If the authentication is successful, at step S330, the controller 130 checks whether a hash value of a policy file corresponding to the corresponding device ID stored in the storage unit 110 is identical with a hash value of the policy file request message through a comparison.

If, as a result of the check, the hash values are identical, the controller 130 determines that the policy file has not been updated. At step S350, the controller 130 transmits, to the corresponding device 200, a policy file request response message providing notification that the policy file has not been updated through the communication unit 110.

If, as a result of the check, the hash values are different, the controller 130 determines that the policy file of the corresponding device 200 has been updated. At step S340, the controller 130 transmits, to the corresponding device 200, a policy file request response message including an updated policy file through the communication unit 110.

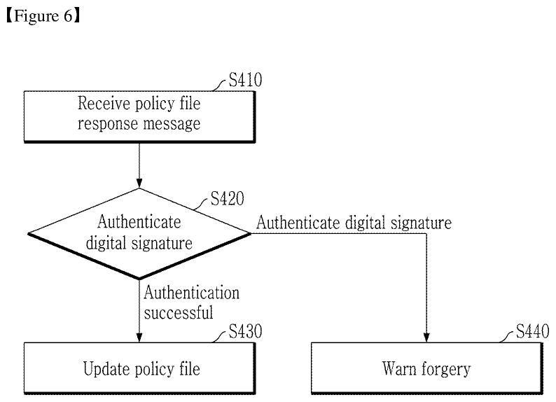

A method of receiving a policy file by the device 200 is described more specifically below. FIG. 6 is a flowchart for describing a method for Internet access control of an IoT device by the device according to an embodiment of the present invention.

Referring to FIG. 6, at step S410, the policy file manager 231 of the control module 230 of the device 200 may receive a policy file response message through the communication module 210.

Thereafter, at step S420, the policy file manager 231 authenticates the digital signature of the policy file response message. The policy file response message includes a policy file and a digital signature obtained by signing a corresponding device ID using the private key of the policy file server 100. Accordingly, the policy file manager 231 extracts the device ID from the digital signature, obtained by signing the corresponding device ID using the private key of the policy file server 100, using the public key of the policy file server 100, and authenticates the policy file response message by verifying whether the extracted device ID is identical with the device ID of the corresponding device.

If the authentication is successful, at step S430, the policy file manager 231 updates the existing policy file with the policy file of the policy file response message. Accordingly, the device 200 may perform access control through the updated policy file.

In contrast, if the authentication fails, at step S440, the policy file manager 231 may transmit, to the policy file server 100, a forgery report to warn that a policy file request message has been forged or falsified through the communication module 210. Accordingly, the policy file server 100 may transmit, to the manager apparatus 300, the forgery report providing notification that the policy file request message has been forged or falsified.

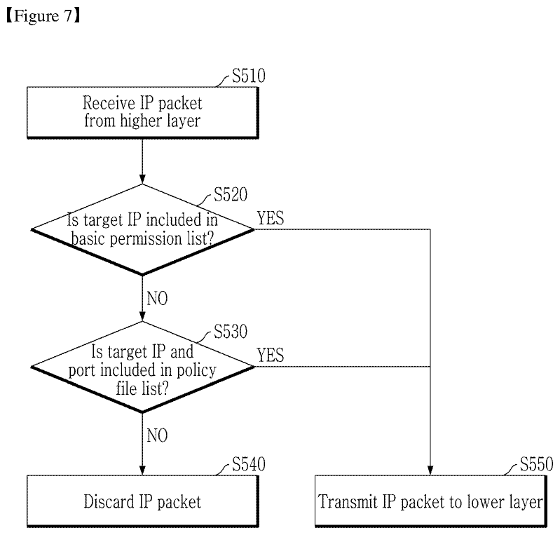

A method of performing, by the device 200, access control through a policy file is described below. FIG. 7 is a flowchart for describing a method for Internet access control of an IoT device by the device according to an embodiment of the present invention.

Referring to FIG. 7, it is assumed that the storage module 220 of the device 200 has stored a basic permission list and a policy file received from the policy file server 100. The basic permission list includes an IP that needs to be basically used by the device 200. For example, the basic permission list includes the IP, local IP, gateway IP, domain name server (DNS) IP, etc. of the policy file server 100. The policy file specifies a destination IP and port to which access is approved.

The access control filter module 233 of the control module 230 of the device 200 operates in an IP layer.

At step S510, the access control filter module 233 may receive an IP packet from a higher layer. In response thereto, at step S520, the access control filter module 233 determines whether the destination IP of the received IP packet is included in the basic permission list.

If, as a result of the determination at step S520, the destination IP of the received IP packet is included in the basic permission list, the access control filter module 233 proceeds to step S550 and transmits the corresponding IP packet to a lower layer. Accordingly, the corresponding IP packet may be delivered to the destination IP.

In contrast, if, as a result of the determination at step S520, the destination IP of the received IP packet is not included in the basic permission list, the access control filter module 233 proceeds to step S530 and determines whether the destination IP and port of the IP packet are included in a destination IP and port to which access is approved by the policy file.

If, as a result of the determination at step S530, the destination IP and port of the IP packet are not included in the policy file, the access control filter module 233 discards the corresponding IP packet at step S540.

In contrast, if, as a result of the determination at step S530, the destination IP and port of the IP packet are included in the policy file, the access control filter module 233 proceeds to step S550 and transmits the corresponding IP packet to a lower layer. Accordingly, the corresponding the IP packet may be delivered to the destination IP.

Meanwhile, the aforementioned methods according to the embodiments of the present invention may be implemented in the form of a program readable through various computer means, and may be written in a computer-readable recording medium. In this case, the recording medium may include program instructions, a data file, and a data structure alone or in combination. The program instructions written in the recording medium may be specially designed and constructed for the present invention, or may be known and available to those skilled in computer software. For example, the recording medium include magnetic media such as a hard disk, a floppy disk and a magnetic tape, optical media such as a CD-ROM and a DVD, magneto-optical media such as a floptical disk, and hardware devices specially configured to store and execute program instructions, such as a ROM, a RAM, and a flash memory. Examples of the program instructions may include not only a machine language wire constructed by a compiler, but a high-level language wire capable of being executed by a computer using an interpreter. Such a hardware device may be configured to act as one or more software modules in order to perform an operation of the present invention, and vice versa.

Although the present invention has been described using some preferred embodiments, these embodiments are illustrative and are not restrictive. As described above, a person having ordinary knowledge in the field to which the present invention pertains may understand that the present invention may be variously changed and modified based on doctrine of equivalents without departing from the spirit of the present invention and the range of rights described in the claims.

### INDUSTRIAL APPLICABILITY

The present invention can improve data transmission security of an IoT device by allowing the IoT device to not transmit data through an unapproved IP and port and implementing the Internet access control through only a destination IP and port to which access has been approved. Accordingly, the present invention has the industrial applicability because it can be sufficiently available or on the market and practically implemented evidently.

1. A policy file server for Internet access control, comprising:
a storage unit storing a policy file to specify a destination IP and port to which access has been approved with respect to each of a plurality of devices;
a communication unit receiving, from any one of the plurality of devices, a policy file request message comprising a device ID and a hash value of a policy file already received by the device; and
a controller updating a policy file for the plurality of devices in a given cycle, determining whether the policy file has been updated based on the hash value of the device when the policy file request message is received, and transmitting, to the device, a policy file response message comprising the updated policy file through the communication unit if the policy file has been updated.

2. The policy file server of claim 1, wherein:
the policy file request message further comprises a digital signature of the device, and
the controller
verifies forgery of the policy file request message based on the digital signature, and
transmits, to a manager apparatus, a warning message providing notification that the policy file request message has been forged through the communication unit if, as a result of the verification, the policy file request message has been forged.

3. The policy file server of claim 1, wherein the controller
periodically receives an IP use speed from each of the plurality of devices,
classifies the plurality of devices into a plurality of groups based on the IP use speeds, and
updates a policy file based on each of the classified groups.

4. A device for Internet access control, comprising:
a storage module storing a basic permission list to specify a destination IP to which access has been approved and a policy file to specify a destination IP and port to which access has been approved;
a communication module for communication with a policy file server; and
an access policy file manager receiving an updated policy file from the policy file server in a given cycle through the communication module.

5. The device of claim 4, further comprising an access control filter module determining whether a destination IP of an IP packet is included in the destination IP specified by the basic permission list when the IP packet is received from an IP layer, determining whether the destination IP and port of the IP packet are included in the destination IP and port to which access has been approved by the policy file if, as a result of the determination, the destination IP of the IP packet is not included in the destination IP specified by the basic permission, and transmitting the IP packet to a lower layer if, as a result of the determination, the destination IP of the IP packet is included in the destination IP specified by the basic permission.

6. A method for Internet access control by a policy file server, the method comprising steps of:
updating a policy file to specify a destination IP and port to which access has been approved in a given cycle with respect to each of a plurality of devices;
receiving, from any one of the plurality of devices, a policy file request message comprising a device ID and a hash value of a policy file already received by the device; and
determining whether the policy file has been updated based on the hash value of the device and transmitting, to the device, a policy file response message comprising the updated policy file if the policy file has been updated.

7. A method for Internet access control by a device, the method comprising steps of:
storing a basic permission list to specify a destination IP to which access has been approved;
storing a policy file to specify a destination IP and port to which access has been approved and updating the policy file in a given cycle;
determining whether a destination IP of an IP packet is included in the destination IP specified by the basic permission list when the IP packet is received from an IP layer;
determining whether the destination IP and port of the IP packet are included in the destination IP and port to which access has been approved by the policy file if, as a result of the determination, the destination IP of the IP packet is not included in the destination IP specified by the basic permission list; and
transmitting the IP packet to a lower layer if, as a result of the determination, the destination IP and port of the IP packet are included in the destination IP and port to which access has been approved by the policy file.
